(19) United States
(12) Patent Application Publication
(10) Pub. No.: US 2006/0008629 A1
(43) Pub. Date: Jan. 12, 2006

(54) Molded article, injection molding method and apparatus

(75) Inventors: Atushi Yusa, Ibaraki-shi (JP); Terumasa Kondo, Nagano (JP)

Correspondence Address: BIRCH STEWART KOLASCH & BIRCH, PO BOX 747, FALLS CHURCH, VA, 22040-0747, US

(73) Assignee: HITACHI MAXELL, LTD., Osaka (JP)

(21) Appl. No.: 10/990,414

(22) Filed: Nov. 18, 2004

(30) Foreign Application Priority Data
Nov. 19, 2003 (JP) 2003-389319

(51) Int. Cl. B05D 5/00

(52) U.S. Cl. 428/220; 427/256; 427/248.1

(57) ABSTRACT

A molded article includes thermoplastic resin, and an organic material different from the thermoplastic resin inside said molded article, the organic material being located on and near a surface of said molded article.

This application claims the right of priority under 35 U.S.C. §119 based on Japanese Patent Application No. 2003-389319, filed on Nov. 19, 2003, which is hereby incorporated by reference herein in its entirety as if fully set forth herein.

### BACKGROUND OF THE INVENTION

The present invention relates generally to molded articles, methods for manufacturing the molding methods and apparatuses, and surface treatment methods, and more particularly to a molded article that is made of a thermoplastic resin (or molten resin) and has a modified surface, a molding method that utilizes a surface modification, a molding apparatus used for the molding method, and a surface treatment method of a molded article which utilizes the surface modification.

A wide variety of plastic molded articles are made using injection molding, and the plasticized molten resin materials determine their physical properties. The plastic molded article may be subject to various types of printing, coating, formations of electric conductors and metal films, junctions with another molded article, and other posttreatments. These necessary posttreatments generally activate a surface of the plastic molded article for surface modification and processing improvement.

On the other hand, the electroless plating is widely used to form a metal conductor film on a surface of an electronic apparatus made of the plastic molded article. The electronic plating procedure to plastic is generally pursuant to a flowchart shown in FIG. 9 although it slightly differs according to materials and other conditions.

The “degreasing” step initially removes the oil etc. from the surface of the molded article, and the “etching” step roughs the surface. The etching uses chrome acid solution and alkali metal hydroxide solution. The etchant requires a posttreatment, such as neutralization, causing increased cost, and the toxic etchant is problematic in handling. The “wetting” step then improves wettability using a process with surfactant solution, and the “catalyst (catalyzing)” step attaches catalyst to the plastic surface. For palladium catalyst, the “catalyzing” process impregnates the plastic into hydrochloric acid solution consisting of stannous chloride and palladium chloride. After the “catalyzing” step, the “accelerator (catalyst activation)” step activates plating catalyst using acid, such as sulfuric acid and hydrochloric acid. The “electroless plating” is not available until these processes finish.

Some processes have conventionally been proposed which rough a surface without etching (see for example, Japanese Patent Applications, Publication Nos. 9-59778 and 2001-303255). These references propose to form a thin film including plating catalyst on a plastic surface using organic binder and UV cure resin. Similarly, as disclosed, for example, in Japanese Patent Application, Publication No. 6-87964, technology has already known which irradiates ultraviolet (“UV”) laser onto and modifies a plastic surface in an atmosphere of gas, such as amine compounds. Other known surface modification technologies include corona discharge treatments, plasma treatments and UV treatments.

A semi-additive method has been known as one of methods that form wiring on a circuit board using electroless plating and electrolysis plating. FIG. 10 shows this flow. This method uses the “electroless plating” step to form a plated layer with a thickness of 1 to 2 μm on the entire substrate using the same steps as discussed above. Then, the “exposure and development” step follows with masking after a “photosensitive film and resist” are formed, so as to form film and resist layers that include a wiring pattern. The “electrolysis plating” step forms an electrolysis plated layer on the electroless plated layer that has exposed. After the film and resist are removed, soft etching forms plated wires by removing the electroless plated layer from part other than the wiring part. Due to bad adhesion properties with resin, the copper plating would sometimes require a posttreatment referred to as “black treatment”, which creates fine projections made of copper (oxide) to enhance an anchor effect with the resin.

Methods have been also conventionally proposed which provide a molded article with a three-dimensional circuit (see, for example, Japanese Patent Applications, Publication Nos. 4-76985 and 1-206692). These methods initially form a plastic three-dimensional circuit board by resin molding. Then, an electroless plated layer is entirely formed and the photoresist is entirely applied after the surface is made rough and catalyzed. The surface is exposed through a photomask, and developed to remove part other than circuit-pattern forming part. After the electrolysis plating and electroless plating using Ni and Au follow, photoresist is peeled off and unnecessary portion of the electroless plating is removed. It is difficult to form the photoresist as a uniform three-dimensional structure. Japanese Patent Application, Publication No. 4-76985 proposes to use electrodeposition resist, but this resist has disadvantageously low alkali resistance.

A method for forming a three-dimensional circuit while maintaining a flat surface of an injection-molded article has also been proposed (see, for example, Matsushita Electric Technical Report August of 2002). This reference discloses surface modifications using vacuum plasma processing to a surface of an injection-molded article, a formation of a metal membrane using copper etc. with sputtering, and electronic plating after a pattern is formed by direct drawing using a laser. This process does not deteriorate surface roughness unlike the conventional etching, but has a disadvantage in a limited type of base plastic material so as to maintain the adhesion characteristic with the sputtered membrane.

On the other hand, along with recent larger signal transmission amounts, circuit boards is very likely to handle high frequencies, and a delayed signal transmission speed becomes problematic. One important solution for this problem is a reduction of the dielectric constant and dissipation factor of a substrate. Accordingly, a method for reducing the lowered dielectric constant is proposed which produces a plastic base material with a high expansion ratio, for example, by using physical and chemical blowing agents, such as supercritical fluid and carbon oxide gas (see, for example, Japanese Patent Application, Publication No. 7-202439). However, the conventional approach of expanding the base material inevitably weakens the strength of the base material.

No technologies have yet been proposed which may provide an efficient and easy surface modification to molded articles and have a wide variety of applications. In addition, the conventional plastic electroless plating processes are complex and expensive as well as being problematic in handling waste disposal of many hazardous materials. No processes are proposed which easily provide thermoplastic resin materials with an electric circuit in a wide variety of applications, or no molded articles and molding methods which restrain the lowered strength of the base material while blowing only primary coat part of the electric circuit pattern.

### BRIEF SUMMARY OF THE INVENTION

Accordingly, in order to solve the above disadvantages, it is an exemplified object of the present invention to provide a molded article that has an entirely or locally modified surface with an easy process but without roughing the surface or using a large amount of hazardous materials so that the surface is applicable, for example, to the electroless plating. It is also an exemplified object of the present invention to provide a molding method of the molded article, and a molding apparatus used to the molding method.

A molded article according to one aspect of the present invention includes a convex part on a surface of the molded article, the molded article being made of thermoplastic resin, and an organic material, different from the thermoplastic resin inside the molded article, the organic material being located on and near a surface of the convex part. The term “near a surface of the molded article” means “in the molded article and close to the surface”, and properly defined by an object of surface modification and materials to be used, preferably within 100 μm from a surface, and more preferably within 10 μm from a surface. Since the organic material is included on or near the surface of the convex part, the surface of the molded article can be modified by the action of the organic material. The modified part may be an entire surface or part of the surface of the molded article.

The convex part preferably has an elongated shape and having a sectional area between 0.005 mm² and 0.5 mm² on a plane orthogonal to a longitudinal direction of the convex part. When the sectional area of the convex part is smaller than 0.005 mm², the thermoplastic resin material is insufficient and the supercritical fluid, which will be described later, cannot expand this part properly. On the other hand, when the sectional area of the convex part is greater than 0.5 mm², the cellular porous media become too large to precisely form a wiring pattern on this convex part. When the convex part expands, the dielectric ratio reduces after the wiring pattern is formed on the convex surface. When the wiring patterns are isolated from each other on the surface of the convex part, an effect of the dielectric ratio reduction enhances.

The organic material may include at least one of polyethylene glycol, dyestuff, fluoric low-molecular monomer, silicone oil, fluoric high-molecular monomer, and silicone polymer. Polyethylene glycol makes the organic material hydrophilic, and the dyestuff makes the organic material colorful. Fluoric low-molecular monomer and silicone oil make the organic material hydrophobic. The convex part may include metallic complex, and the metallic complex may be partially reduced to metal particles.

Since the metallic particles reduced from the metallic complex infiltrate as catalyst cores in the molded article, the adhesion to a surface treating membrane (such as plated membrane) improves even when the convex part does not have a rough surface. Examples of the metallic complex include bis (cyclopentadienyl) nickel, bis (acetylacetnate) paradium (II), dimethyl platinum (cyclooctadiene) (II), hexafluoro acetylacetnate paradium (II), hexafluoro acetylacetnate hydrate copper (II), hexafluoro acetylacetnate platinum (II), hexafluoro acetylacetnate (trimethylphosphine), Ag (I), dimethyl (heptafluoro octanedionate) Ag (AgFOD), etc.

A type of thermoplastic resin is arbitrary, and may include at least one of polycarbonate, polymethyl-methacrylate, cycloaliphatic olefin resin, poly(ether-imid), polymethyl pentene, amorphous polyolefin, polytetrafluoro-ethylene, liquid crystal polymer, styrene resin, polymethyl pentene, polyacetal, polyamid resin, polyimid, and polyamid-imid. Of course, the thermoplastic resin may use a combination of the above plural types, and polymer alloy that contains at least one of them as a main component, and add various types of fillers. The present invention is applicable to a film-shaped molded article having a thickness of 200 μm or smaller.

A molding method according to another aspect of the present invention include the steps of accommodating in a mold, a molded article made of thermoplastic resin, clamping the mold with a first pressure so as to retain the molded article, and impregnating supercritical fluid that contains an organic material different from the supercritical fluid, into a surface of the molded article, and including the organic material into the surface of the molded article.

According to this method, the supercritical fluid reduces the glass transition temperature on the surface of the molded article, and infiltrates in the swelled molded article. Since the supercritical fluid contains the organic material (functional organic material) and the organic material deeply infiltrates in the molded article, a highly durable surface modified membrane can be obtained unlike coating, etc. Since a simple method can modify a surface of the molded article made of thermoplastic resin (so-called plastic molded article, e.g., a film made of thermoplastic resin), which has been produced by injection molding, extrusion molding, casting, etc.

The surface modification may use, for example, an aperture formed between the mold and the molded article to introduce the supercritical fluid through the aperture. In order to modify a specific portion of the molded article, a channel corresponding to the specific portion is formed in the mold so as to introduce the supercritical fluid through the channel. Since the glass transition temperature lowers and the molded article softens, the molded article can be made partially deformable or shaped, and the high size precision can be maintained similar to the injection molding.

The impregnating step may circulate the supercritical fluid along the channel formed in the mold or impregnating step allows the supercritical fluid to reside in the channel. Thereby, the specific portion is locally surface-modified along the channel. A three-dimensional channel for the supercritical fluid along the surface of the molded article provides a local, three-dimensional surface modification to the molded article. The circulation or residence of the supercritical fluid can effectively promote the surface modification.

The supercritical fluid may include at least one of air, CO, CO₂, O₂, N₂, H₂O, methane, ethane, propane, butane, pentane, hexane, methanol, ethyl alcohol, acetone, and diethyl ether. The supercritical fluid may be CO₂ and have a pressure between 10 MPa and 40 MPa, and a temperature between 40° C. and 150° C. CO₂ is preferable because it has solubility similar to that of n-hexane, serves as a plasticizer to certain thermoplastic resin materials, and is famous for high performance in injection molding and extrusion molding. Of course, the organic material may be any one of the above examples.

In some instances, the supercritical fluid preferably uses supercritical N₂. In order to impregnate metallic complex as the organic material into a surface of a molded article and to partially foam the surface, supercritical fluid is introduced as blowing gas that does not contain metallic complex into the surface of the molded article, after the supercritical fluid that contains metallic complex is circulated. In this case, when the blowing gas is supercritical CO₂, supercritical CO₂ can extract the functional agent, such as metallic complex, that has once infiltrated into the surface of the molded article. Supercritical N₂ is less likely to act as a solvent, and has a reduced extracting force, solving this problem. One of various views for this reason says that supercritical N₂ can make a foam cell diameter smaller than supercritical CO₂. The present invention can utilize this characteristic.

The supercritical fluid may contain assistant, such as acetone, ethanol or other alcohols, for improving solubility of the organic material and for promoting the surface modification of the molded article. When the mold is clamped with a second pressure greater than the first pressure for press molding of the molded article, the press-molded article can be obtained with high size precision.

The impregnating step may lower a glass transition temperature of the surface of the molded article, and the clamping step may form a convex part on the surface of the molded article. Since the supercritical fluid lowers the glass transition temperature of the surface of the molded article, the molded article can be deformed easily. Therefore, the convex part for a wiring pattern can be easily formed with high size precision.

A molding method according to another aspect of the present invention includes the steps of accommodating in a mold a molded article made of thermoplastic resin, clamping the mold with a first pressure to retain the molded article, impregnating supercritical fluid locally into a surface of the molded article, and decompressing the molded article around the surface after the impregnating step, and expanding the surface of the molded article.

The decompressing step is preferably conducted at a temperature below a glass transition temperature of the thermoplastic resin. The dielectric ratio reduces when the supercritical fluid locally infiltrates around the surface in the molded article and decompresses the molded article around the surface to expand the part. Therefore, this method is advantageous to a local formation of a wiring pattern at the specific portion of the molded article.

A molding apparatus include a mold that accommodates a molded article made of thermoplastic resin, a pressing unit that opens and closes the mold, and a supercritical fluid generator that generates supercritical fluid, wherein the mold includes a channel for introducing the supercritical fluid into the mold.

According to this method, the supercritical fluid reduces the glass transition temperature on the surface of the molded article, and infiltrates in the swelled molded article. Since the supercritical fluid contains the organic material the organic material deeply infiltrates in the molded article, a highly durable surface modified membrane can be obtained unlike coating, etc. Since a simple method can modify a surface of the molded article made of thermoplastic resin (so-called plastic molded article, e.g., a film made of thermoplastic resin), which has been produced by injection molding, extrusion molding, casting, etc.

The surface modification may use, for example, an aperture formed between the mold and the molded article to introduce the supercritical fluid through the aperture. In order to modify a specific portion of the molded article, a channel corresponding to the specific portion is formed in the mold so as to introduce the supercritical fluid through the channel. Since the glass transition temperature lowers and the molded article softens, the molded article can be made partially deformable or shaped, and the high size precision can be maintained similar to the injection molding.

A mold according to still another aspect of the present invention includes an accommodation part for accommodating a molded article, and an introducing part that includes a channel for impregnating supercritical fluid into a surface of the molded article, and for forming a convex part on the surface by pressing the molded article. Use of this mold for a molding apparatus provides similar effects to those of the above molding apparatus.

A surface treatment method according to another aspect of the present invention includes the steps of impregnating supercritical fluid that contains metallic complex, into a surface of a molded article made of thermoplastic resin, partially reducing the metallic complex so as to allow metallic particles to separate out on the surface of the molded article, and processing the surface of the molded article by electroless plating, at which surface the metallic particles has separated out.

According to this method, since the supercritical fluid reduces the glass transition temperature on the surface of the molded article and the supercritical fluid and metallic complex deeply infiltrate in the swelled molded article, a highly durable surface modified membrane can be obtained unlike coating, etc. In addition, since the metallic particles reduced from the metallic complex infiltrate as catalyst cores in the molded article, the adhesion to a surface treating membrane (such as electroless plated membrane) improves even when the convex part does not have a rough surface.

Other objects and further features of the present invention will become readily apparent from the following description of preferred embodiments with reference to accompanying drawings.

### BRIEF DESCRIPTION OF THE DRAWINGS

FIG. 1 is a block diagram of a schematic structure of a molding apparatus according to a first embodiment of the present invention.

FIG. 2 is block diagram showing that a molded article is housed in a mold in the molding apparatus shown in FIG. 1.

FIG. 3 is a partially enlarged sectional view of part A in FIG. 2 and shows a clamping state with a first pressure.

FIG. 4 is a partially enlarged sectional view of part A in FIG. 2 and shows that the supercritical fluid infiltrates through the molded article.

FIG. 5 is a partially enlarged sectional view of part A in FIG. 2 and shows that the supercritical fluid containing metallic complex circulates.

FIG. 6 is a partially enlarged sectional view of part A in FIG. 2 and shows that the supercritical fluid infiltrates in the molded article.

FIG. 7 is a partially enlarged sectional view of part A in FIG. 2 and shows a clamping state with a second predetermined pressure.

FIG. 8 is a sectional view showing a structure of a molded article obtained by a process according to the first embodiment of the present invention.

FIG. 9 is a flowchart of a conventional electroless plating method.

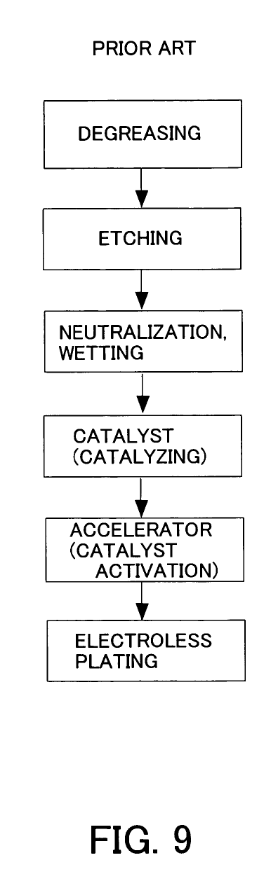

FIG. 10 is a flowchart for explaining a semi-additive method a conventional plating wiring method.

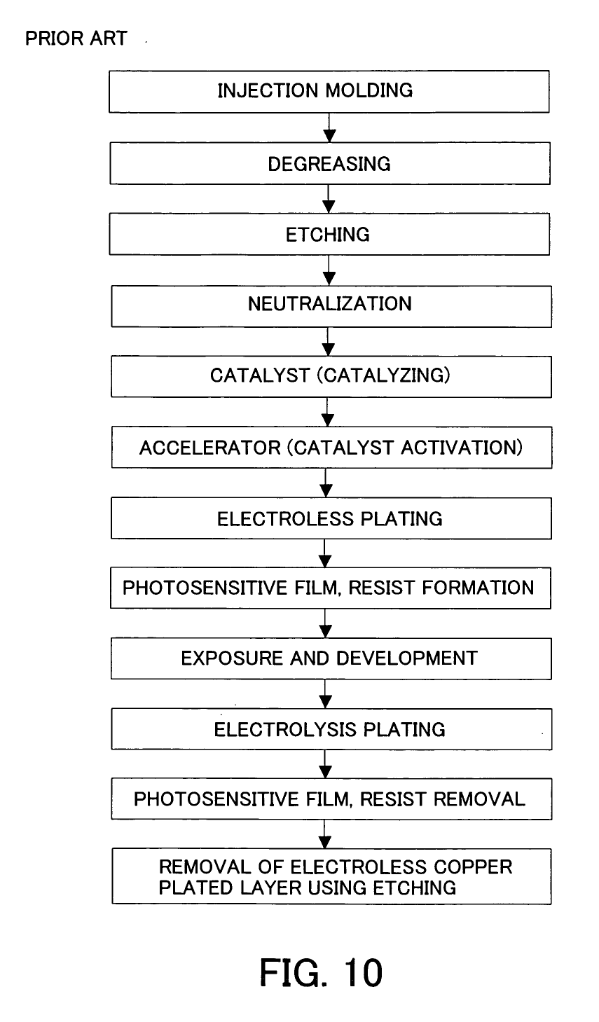

FIG. 11 is a graph showing a curve fit of the Pd3d binding energy spectrum under the X-ray photoelectron spectroscopy.

### DETAILED DESCRIPTION OF THE PREFERRED EMBODIMENTS

### First Embodiment

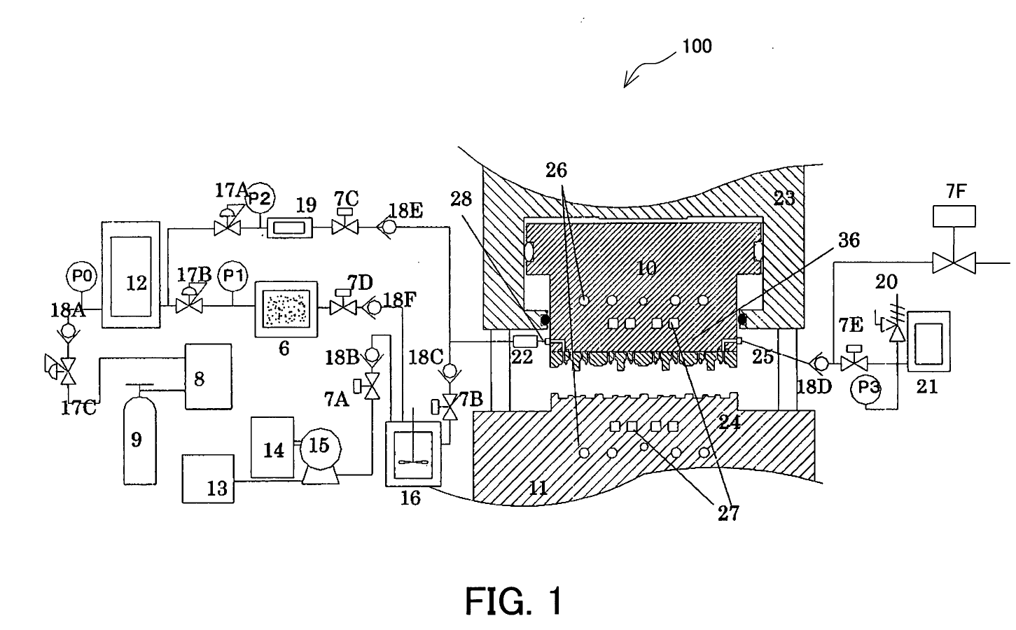

A description will be given of a molding apparatus and method according to a first embodiment of the present invention, with reference to FIGS. 1 to 8. FIG. 1 is a block diagram of a schematic structure of the molding apparatus 100 according to the first embodiment of the present invention. The molding apparatus 100 is a press molding apparatus used for press molding of a molded article. For example, a molded article which has been produced by injection molding or extrusion molding is accommodated and pressed in a mold in this press molding apparatus for partial or entire deformation or shaping.

In these FIGS. 17A to 17C denote decompression valves, 18A to 18F denote check valves, and 7A to 7E denote automatic air valves. While the first embodiment uses CO₂ for supercritical fluid, the usable type of supercritical fluid is not limited to this, and may be air, CO, CO₂, O₂, N₂, H₂O, methane, ethane, propane, butane, pentane, hexane, methanol, ethyl alcohol, acetone, and diethyl ether. While the supercritical condition of CO₂ requires the pressure of 7 MPa or greater and the temperature of 31° C. or greater, the preferable pressure is between 10 MPa and 40 MPa and the preferable temperature is between 40° C. and 150° C.

A functional organic material is dissolved in CO₂ as supercritical fluid. While an arbitrary dissolution method is applicable, the dissolution method of the first embodiment includes the steps of transforming CO₂ supplied from a CO₂ tank 9 into a supercritical state in a supercritical fluid generator 8; maintaining the pressure in a reserve tank 12 at pressure P0 using the decompression valve 17C; and controlling the pressure in a dissolution sink 6 for dissolving the functional organic material in supercritical CO₂, at pressure P1 using the decompression valve 17B. The pressure P0 is 25 MPa, and the pressure P1 is 20 MPa. The heater (not shown) controls the temperature from the pipe and tank from the reserve tank 12 to the filter 22 within a temperature range between 40° C. and 150° C. On the other hand, the temperature in the dissolution sink 6 is maintained at 50° C.

The first embodiment uses bis (acetylacetnate) paradium (II) as the functional material in the dissolution sink 6.

Supercritical CO₂ in which metallic complex is dissolved and entrainer (or assistant) stored in an entrainer tank 14 are mixed and agitated in an agitator sink 16. The entrainer uses, for example, acetone and ethanol and other alcohols. A feedback controller 13 controls an entrainer pump 15 and the automatic valve 7A, and maintains the entrainer concentration constant in the agitator sink 16.

Supercritical CO₂, in which metallic complex (Pd metallic complex) is dissolved as the functional organic material and the entrainer is mixed, is introduced into an upper mold 36 through an introduction pipe 28 by opening and closing actions of the automatic valve 7B. Introduced supercritical CO₂ circulates in a channel, which will be described later, in the upper mold 36 and then exhausted through an exhaust pipe 25 by opening and closing actions of the automatic valve 7E. Exhausted supercritical CO₂ is guided to a recovery sink 21, and separated into respective components for recovery. A relief valve 20 automatically decompresses the recovery sink 21 to pressure P3, which is 1 MPa.

Supercritical CO₂ (which does not contain the functional organic material or entrainer) that has been stored in the reserve tank 19 while the decompression valve 18A maintains its pressure at pressure P2, is introduced to the upper mold 36 by opening and closing actions of the automatic valve 7C. The pressure P2 is 23 MPa. This structure enables the insides of the pipes 25 and 28 and the channel in the upper mold 36 to be cleansed to recover the functional organic material remaining in them. The decompression of the channel in the upper mold 36 can expand the surface of the molded article partially or entirely.

This molding apparatus 100 includes a lower mold 24 integrated with a lower plate 11, a hydraulic piston 10 installed in a hydraulic cylinder 23, and the upper mold 3 integrated with the hydraulic piston 10. The hydraulic cylinder 23 can apply the maximum pressure of 30 tons. While the first embodiment describes that the upper mold 36 forms the channel for introducing supercritical CO₂, the channel may be formed in the lower mold 24 or in both the upper and lower molds 24 and 36. A heater 26 and temperature control circuit 27 are respectively provided in the upper and lower molds 24 and 36 so as to provide two types of temperature controls. The heater 26 can heat up to 400° C. The temperature control circuit 27 can control the temperatures of the upper and lower molds 24 and 36 within a range between 30° C. and 145° C.

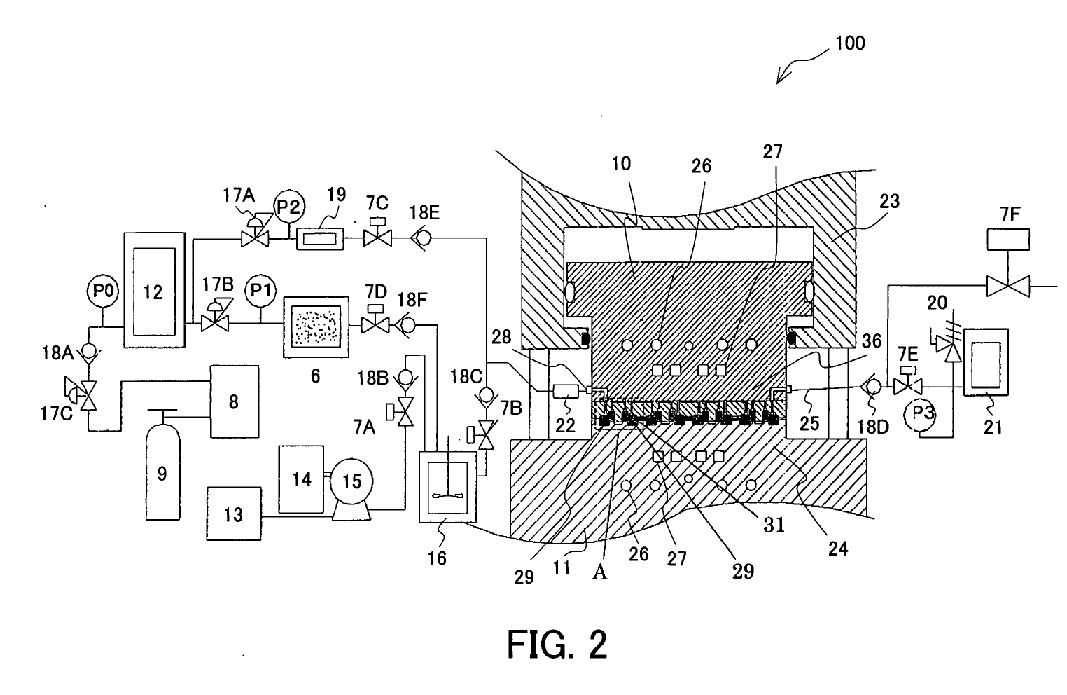

A description will be given of pressing and a surface modification process to the molded article using this molding apparatus 100. First, as shown in FIG. 2, a molded article 29 made of thermoplastic resin is accommodated between the upper and lower molds 36 and 24. This molded article 29 is made of plastic having a three-dimensional shape, for example, by injection molding. The conceivable materials applicable to the thermoplastic resin are, for example, polycarbonate, polymethyl-methacrylate, cycloaliphatic olefin resin, poly(ether-imid), polymethyl pentene, amorphous polyolefin, polytetrafluoro-ethylene, liquid crystal polymer, styrene resin, polymethyl pentene, polyacetal, polyamid resin, polyimid, polyamid-imid, etc., but may include other materials. The molded article may have an arbitrary shape, such as a film-shaped molded article having a thickness of 200 μm or smaller. The first embodiment uses cycloaliphatic olefin resin (ZEON Corporation, Zeonex® 480R) having the glass transition temperature of about 150° C. for the thermoplastic resin. 4 pieces per row and 4 pieces per line, totally 16 pieces of products are connected via a runner 31 to form the molded article, where each piece has a size of 7 mm×7 mm×1.5 mm.

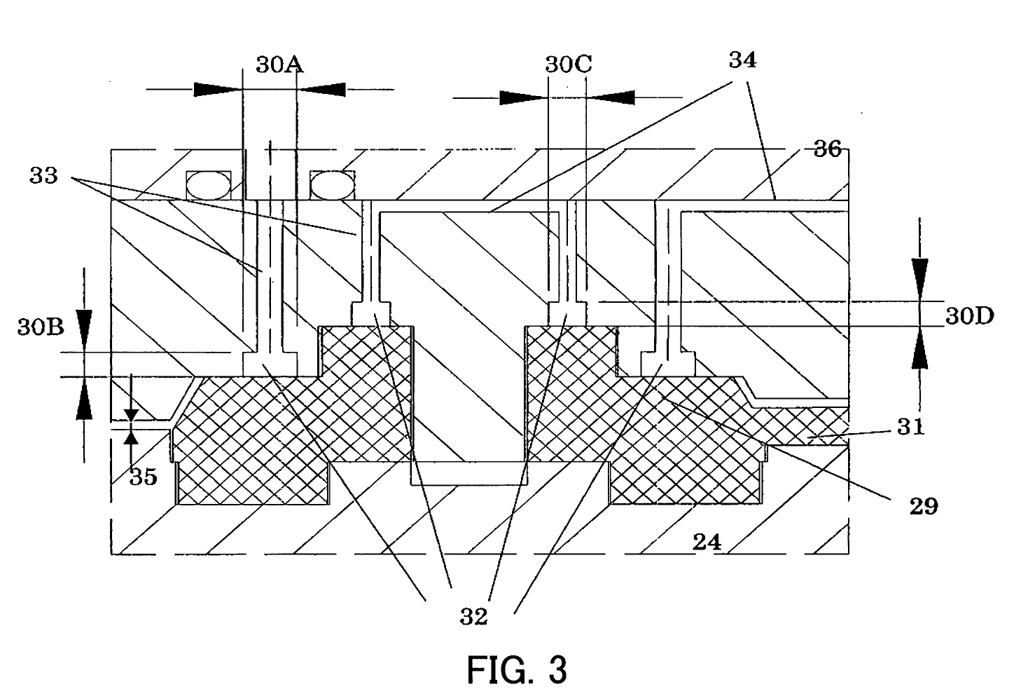

FIG. 3 is an enlarged sectional view that partially enlarges part A in FIG. 2. In this figure, the molded article 29 is clamped at a first pressure of 10 tons between the upper and lower molds 24 and 36. The first pressure is a relatively low pressure, and the upper and lower molds 24 and 36 retain the molded article 29 while pressure clearance 35 is remained. The temperatures of the upper and lower molds 24 and 36 are adjusted to 130° C. lower than the glass transition temperature of the molded article 29.

The upper mold 36 has a concave channel 32 for allowing supercritical CO₂ to circulate and reside. The channel 32 is used for a surface modification of the molded article 29 at a specific portion. The channel 32 forces the specific portion of the molded article 29 to follow its shape during deformation. In the first embodiment, a groove width 30A is 0.3 mm, a groove depth 30B is 0.1 mm, a groove width 30C is 0.1 mm, and a groove depth 30D is 0.1 mm. While these channels 32 have elongated shapes in a direction perpendicular to the paper surface of FIG. 3, their sectional areas are preferably set between 0.005 mm² and 0.5 mm² on a plane orthogonal to their longitudinal directions, or a plane parallel to the paper surface. In the first embodiment, these areas are 0.01 mm² and 0.03 mm², respectively. The channels 32 can be formed in the lower mold 24 or both the upper and lower molds 24 and 36. An arrangement of the channel 32 is determined in accordance with which portion should be surface-modified among the surfaces of the molded article 29.

These channels 32 are connected to each other via a connection groove 34 provided at the top of the upper mold 36 and a vent hole 33 that connects the connection groove 34 and the channel 32, facilitating introductions and exhaustions of supercritical CO₂.

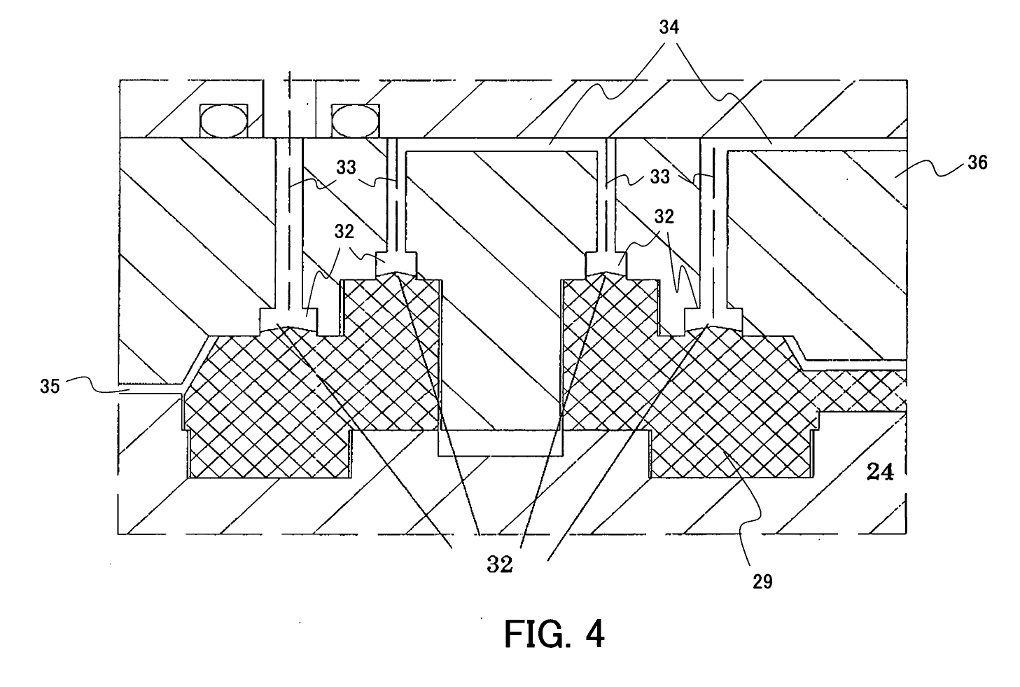

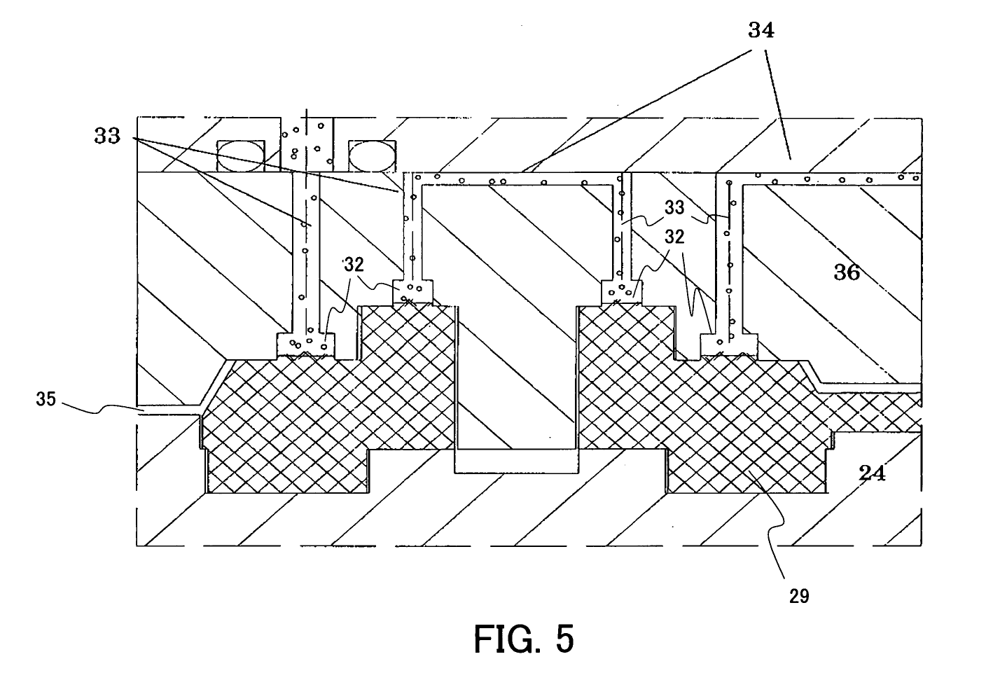

After pressing for 5 seconds, the automatic valve 7C is released and supercritical CO₂ that does not contain metallic complex or entrainer is introduced in the channel 32. The impregnation of supercritical CO₂ reduces the glass transition temperature of the surface portion of the molded article 29 corresponding to the channel 32 and deforms that portion (see FIG. 4). Then, the automatic valve 7B is released after the automatic valve 7C is closed, and the automatic valve 7E is released so as to introduce supercritical CO₂ in which metallic complex is dissolved, into the channel 32 from the agitator sink 16 and circulate it there (see FIG. 5).

After the circulation for 10 seconds, the automatic valve 7E is closed and this supercritical CO₂ resides in the channel 32 for three minutes. This circulation and residence process repeats three times. Thereby, supercritical CO₂ and metallic complex impregnate in the surface of the molded article 29. Then, the automatic valve 7B is closed and the automatic valve 7C is released. Supercritical CO₂ without metallic complex or entrainer is introduced into the channel 32 again. Thereby, the insides of the channel 32, vent hole 33, and connection groove 34, etc. can be cleansed and the inner residual metallic complex can be removed.

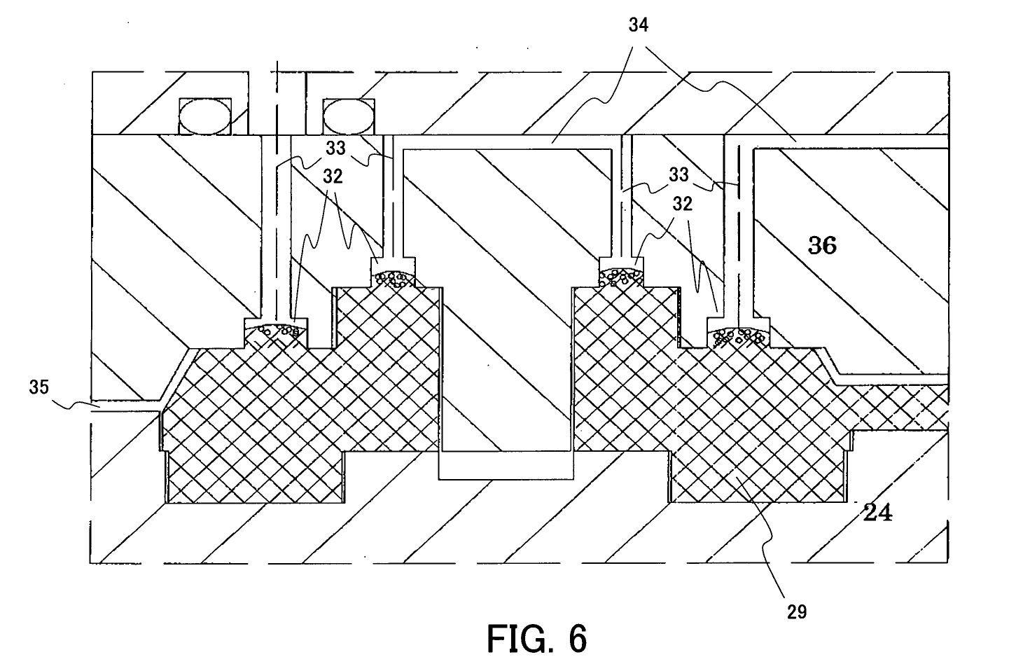

After the automatic valve 7C is closed, the valve 7F is opened and the channel is released to the air. As a consequence, metallic complex locally infiltrate in the specific portion on the surface of the molded article 29 (see FIG. 6).

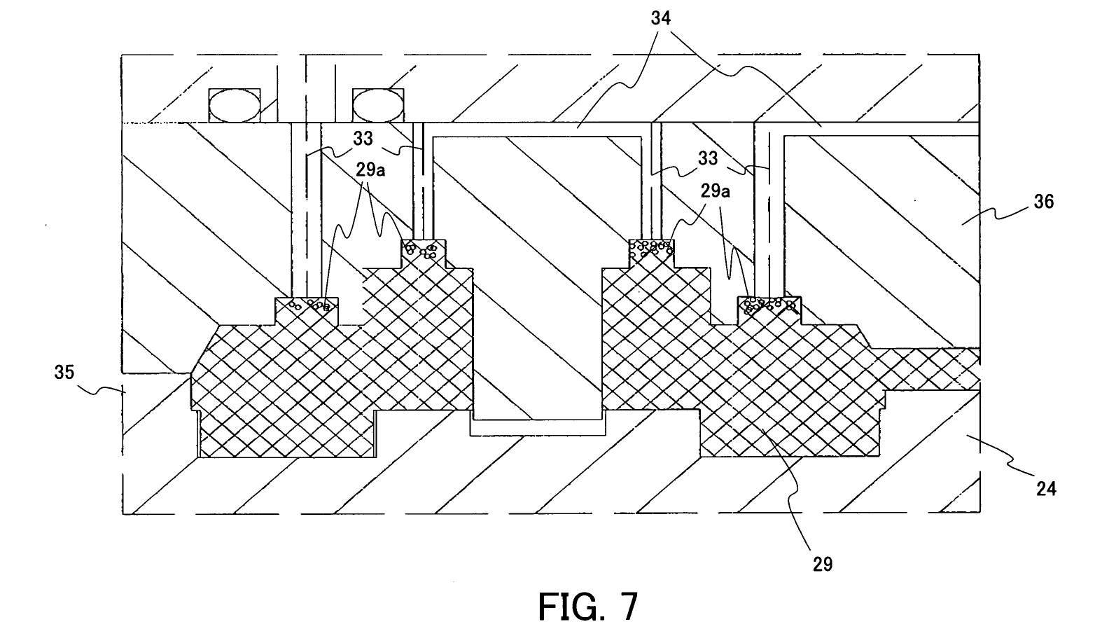

Next, the heater heats the upper and lower molds 24 and 36 for 10 minutes up to 160° C., and the molded article 29 is pressed with a second pressure greater than the first pressure. As shown in FIG. 7, the pressure clearance 35 is eliminated, and the specific portion of the molded article 29 deforms along a shape of the channel 32. Thereby, a convex portion 29a suitable for a wiring pattern can be precisely formed on the surface of the molded article 29. This process can efficiently remove a ligand from metallic complex for catalyst activation. Then, the heater 26 is turned off, the upper and lower molds 24 and 36 are cooled down to 130° C., and the molded article 29 is taken out.

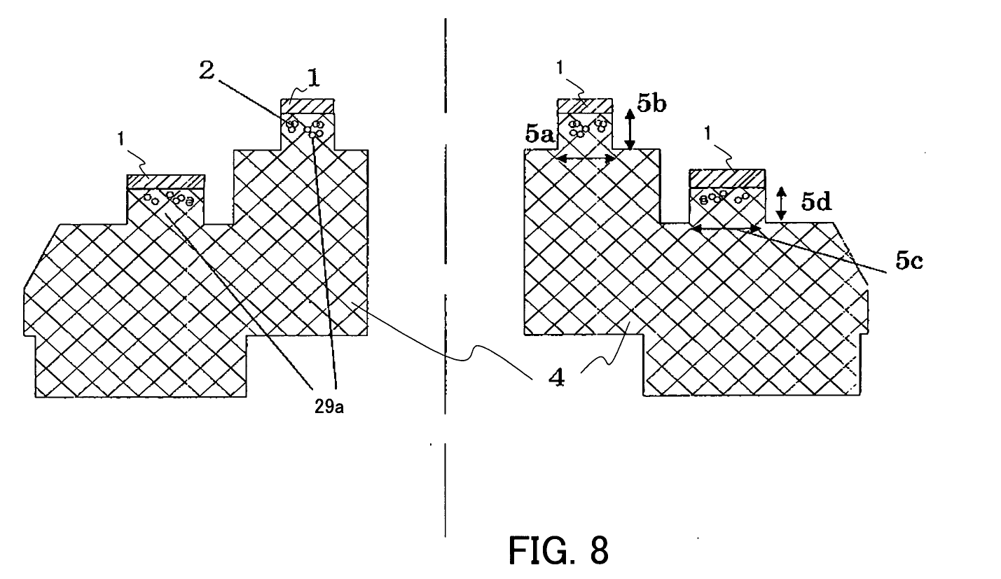

This molded article 29 is put in a container that contains electroless copper plating solution, i.e., Okuno Chemical Industries Co., Ltd., OPC700A of 100 ml/l+Okuno Chemical Industries Co., Ltd., OPC700B of 100 ml/l, and agitated for 10 minutes at a temperature of 60° C. for copper plating processing. After it is cleansed with supersonic waves, pure water and methanol, the copper plated membrane is formed with a thickness of 10 μm on the convex portion 29a of the molded article 29 (see FIG. 8).

It is confirmed that the copper plated membrane 1 has a uniform thickness without swell, and exhibits practically satisfactory adhesive strength in a peel test. According to the resistance measurement that conducts the wiring pattern, it is confirmed that the low resistant wiring is formed without disconnection. It is also confirmed that it exhibited good insulation property between adjacent wires

The runner 31 of molded article 29 is die-cut, and a molded article 4 has a sectional structure shown in FIG. 8. The convex portion 29a of this molded article 4 has two types, i.e., one having a width 5a of 0.1 mm and a height 5b of 0.1 mm, and the other having a width 5c of 0.3 mm and a height 5d of 0.1 mm. The segregations of metallic particles of metallic complex and Pd in either convex part 29a are confirmed by μESCA (Micro Electron Spectroscopy for Chemical Analysis: X-ray photoelectron Spectroscopy: XPS ESCA). The XPS provides types of elements from the binding energy of detected electrons and a ratio of these elements from the signal strength. A point analysis follows in the area of 0.05 μmΦ on the surface of the molded article having the critical dimension 5a of 0.1 mm in the first embodiment. The ESCA machine uses Quantum 2000 of ULVAC-PHI INC. An element ratio of metallic complex is similarly identified. Table 1 shows a result. 2.2 Atomic % of Pd element is detected from the surface of the molded article. A Focused Ion Beam (“FIB”) cuts part with 1 μm from the surface of the molded article. When the part is similarly analyzed, 1.8 Atomic % of Pd element is detected. Thereby, it is clear that the metallic component infiltrates into the uppermost surface down to a certain depth in the molded article of the instant embodiment.

TABLE 1
CALCULATED RESULT OF
ELEMENTARY RATIO (UNIT: Atomic %)

| | C | N | O | Cl | Ni | Pd |
|---|---|---|---|---|---|---|
| COMPLEX | 69.5 | — | 24.0 | — | — | 6.4 |
| MOLDED ARTICLE | 56.9 | 1.5 | 29.5 | 3.6 | 6.3 | 2.2 |

The chemical bonding state on the upper surface of the molded article of the instant embodiment is analyzed using the XPS.

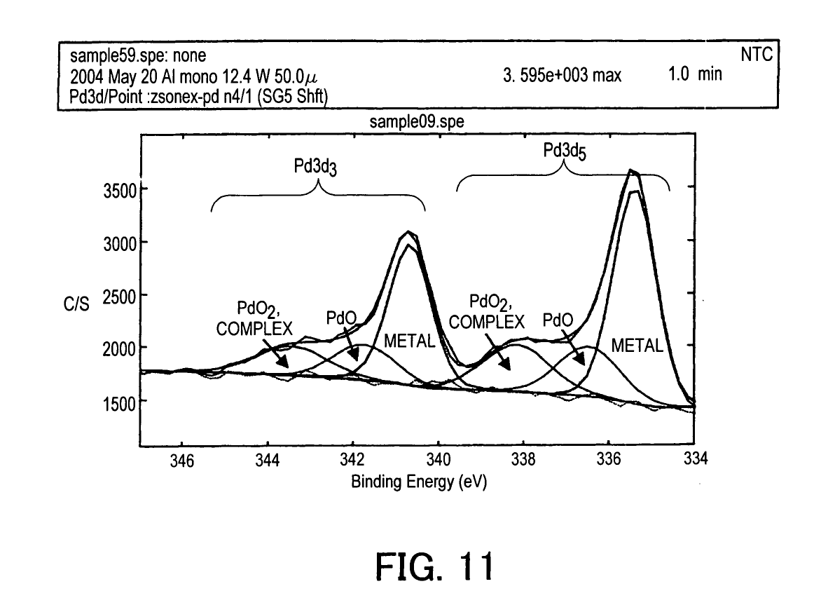

FIG. 11 shows a curve fit of the Pd3d bonding energy spectrum. As shown in FIG. 11, the Pd3d spectrum is broad and separated into waveforms derived from PdO, PdO₂ and Pd complexes in addition to Pd metal. This means that the metallic complex that has infiltrated into the molded article is not completely reduced to metallic elements.

The waveform separation is conducted as shown in FIG. 11 in advance by analyzing the metallic complex powder and calculating a peak of each bonding energy. The Pd metallic component occupies 60% in the waveform separation. On the other hand, PdO complex occupies 20% and a combination of PdO₂ and Pd complexes occupies 20%.

It is understood that 2.2×60%=1.32 (Atomic %) of Pd metallic component serves as a catalyst core in the electroless plating on the surface of the molded article of the instant embodiment which has a critical dimension 5a of 0.1 mm.

### Second Embodiment

Similar to the first embodiment, this embodiment allows supercritical CO₂ that contains metallic complex and entrainer to circulate and reside in the channel 32. Then, in order to efficiently remove a ligand from metallic complex, the heater 26 heats the upper and lower molds 24 and 36 for 10 minutes up to 160° C. Next, the heater 26 is turned off, the upper and lower molds 24 and 36 are cooled down to 130° C., and then the channel 32 is decompressed. The pressure is released with the decompression of the channel 32. Thereby, the atmosphere around the specific portion of the molded article 29 corresponding to the channel 32 is decompressed and the inside of that portion expands.

It is known that foam cells becomes finer and increase as a pressure difference becomes large when the gas is generated from supercritical fluid or the decompression is conducted rapidly. The resin's temperature is preferably maintained low. Since the high temperature reduces the resin's viscosity, the air bubbles continue to grow, and are integrated with each other. Therefore, this decompression process is preferably conducted below the glass transition temperature (Tg) of the thermoplastic resin. In the present invention, Tg indicates physical properties of a bulk material that does not contain supercritical fluid.

Thereafter, the molded article 29 is taken out and subject to the electroless plating. A good Cu wiring pattern can be obtained. An expansion is observed inside the convex portion 29a of the molded article 29 of the second embodiment. This expansion can reduce the dielectric ratio of the wiring pattern. An average foam cell diameter is about 50 μm at the obtained expansion part.

### Third Embodiment

Similar to the second embodiment, in order to efficiently remove a ligand from metallic complex after the channel 32 is released to the air, the heater 26 heats the upper and lower molds 24 and 36 for 10 minutes up to 160° C. Then, supercritical N₂ is introduced at 45° C. and 15 MPa from an inlet (not shown). The heater 26 is then turned off, the upper and lower molds 24 and 36 are cooled down to 130° C., and then the channel 32 is decompressed. The pressure is released with the decompression of the channel 32. Thereby, the atmosphere around the specific portion of the molded article 29 corresponding to the channel 32 is decompressed and the inside of that portion expands.

Thereafter, the molded article 29 is taken out and subject to the electroless plating. A good Cu wiring pattern can be obtained. An expansion is observed inside the convex portion 29a of the molded article 29 of the third embodiment. This expansion can reduce the dielectric ratio of the wiring pattern. An average foam cell diameter is about 30 μm at the obtained expansion part, which is finer than that obtained in the second embodiment.

Further, the present invention is not limited to these preferred embodiments, and various variations and modifications may be made without departing from the scope of the present invention.

Thus, the present invention uses the supercritical fluid to provide high-quality surface modification to the molded article. The present invention can also provide deformation and shape with high size precision in press molding. Since a simple process provides the surface modification without roughing the surface of the molded article, the present invention does not use a large amount of hazardous materials. The surface modification may be provided to the molded article entirely or locally.

What is claimed is:

1. A molded article comprising a convex part on a surface of said molded article, said molded article being made of thermoplastic resin, and an organic material, different from the thermoplastic resin inside said molded article, said organic material being located on and near a surface of said convex part.

2. A molded article according to claim 1, wherein said convex part has an elongated shape and having a sectional area between 0.005 mm² and 0.5 mm² on a plane orthogonal to a longitudinal direction of said convex part.

3. A molded article according to claim 1, wherein said convex part includes cellular porous media.

4. A molded article according to claim 1, wherein said organic material includes at least one of polyethylene glycol, dyestuff, fluoric low-molecular monomer, silicone oil, fluoric high-molecular monomer, and silicone polymer.

5. A molded article according to claim 1, wherein said convex part includes metallic complex.

6. A molded article according to claim 1, wherein said metallic complex is partially reduced to metal particles.

7. A molded article according to claim 1, wherein said thermoplastic resin includes at least one of polycarbonate, polymethyl-methacrylate, cycloaliphatic olefin resin, poly(ether-imid), polymethyl pentene, amorphous polyolefin, polytetrafluoro-ethylene, liquid crystal polymer, styrene resin, polymethyl pentene, polyacetal, polyamid resin, polyimid, and polyamid-imid.

8. A molded article according to claim 1, wherein the molded article is a film-shaped molded article having a thickness of 200 μm or smaller.

9. A molding method comprising the steps of:
accommodating in a mold, a molded article made of thermoplastic resin;
clamping the mold with a first pressure so as to retain the molded article; and
impregnating supercritical fluid that contains an organic material different from the supercritical fluid, into a surface of the molded article, and including the organic material into the surface of the molded article.

10. A molding method according to claim 9, wherein the mold has a channel, and said impregnating step circulates the supercritical fluid along the channel.

11. A molding method according to claim 9, wherein the mold has a channel, and said impregnating step allows the supercritical fluid to reside in the channel.

12. A molding method according to claim 9, wherein the supercritical fluid includes at least one of air, CO, CO₂, O₂, N₂, H₂O, methane, ethane, propane, butane, pentane, hexane, methanol, ethyl alcohol, acetone, and diethyl ether.

13. A molding method according to claim 9, wherein the supercritical fluid is CO₂ and has a pressure between 10 MPa and 40 MPa, and a temperature between 40° C. and 150° C.

14. A molding method according to claim 9, wherein the supercritical fluid contains assistant for improving solubility of the organic material.

15. A molding method according to claim 14, wherein the assistant is alcohol.

16. A molding method according to claim 9, further comprising the step of clamping the mold with a second pressure greater than the first pressure for press molding of the molded article.

17. A molding method according to claim 16, wherein said impregnating step lowers a glass transition temperature of the surface of the molded article, and said clamping step forms a convex part on the surface of the molded article.

18. A molding method comprising the steps of:
accommodating in a mold a molded article made of thermoplastic resin;
clamping the mold with a first pressure to retain the molded article;
impregnating supercritical fluid locally into a surface of the molded article; and
decompressing the molded article around the surface after said impregnating step, and expanding the surface of the molded article.

19. A molding method according to claim 18, wherein said decompressing step is conducted at a temperature below a glass transition temperature of the thermoplastic resin.

20. A molding apparatus comprising:
a mold that accommodates a molded article made of thermoplastic resin;
a pressing unit that opens and closes the mold; and
a supercritical fluid generator that generates supercritical fluid, wherein said mold includes a channel for introducing the supercritical fluid into the mold.

21. A mold comprising an accommodation part for accommodating a molded article, and an introducing part that includes a channel for impregnating supercritical fluid into a surface of the molded article, and for forming a convex part on the surface by pressing the molded article.

22. A surface treatment method comprising the steps of:
impregnating supercritical fluid that contains metallic complex, into a surface of a molded article made of thermoplastic resin;
partially reducing the metallic complex so as to allow metallic particles to separate out on the surface of the molded article; and
processing the surface of the molded article by electroless plating, at which surface the metallic particles has separated out.
